(19) United States
(12) Patent Application Publication
(10) Pub. No.: US 2007/0026954 A1
(43) Pub. Date: Feb. 1, 2007

(54) Driveshaft with a coupling joint for a motor vehicle

(76) Inventors: Gerald Langer, Bulstringen (DE); Armin Ihle, Fuchstal (DE); Walter Pischel, Kaufering (DE); Stephan Lutzenberger, Peiting (DE); Manfred Hirschvogel, Schongau (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/495,028

(22) Filed: Jul. 28, 2006

(30) Foreign Application Priority Data
Jul. 29, 2005 (DE) 102005035578.1

(51) Int. Cl. F16C 3/00

(52) U.S. Cl. 464/179

(57) ABSTRACT

The invention concerns a driveshaft (1) with a drive joint (9) for an vehicle, in which the drive joint (9) features a joint inner portion and joint outer portion (12), which are axially placed into one another and contain rolling elements associated with lead-in tracks (16, 17) between them. In order to make sure that the driveshaft (1) does not break and fall apart in case of impermissibly high torque moments, the joint outer portion (12) is constructed in such a manner that it breaks as a predetermined breaking point of the driveshaft (1) when a predefined torque moment barrier is exceeded.

### CROSS REFERENCE TO RELATED APPLICATIONS

The present application claims International Priority under 35 U.S.C. §119 to co-pending German Patent Application No. 10 2005 035 578.1, filed July 28, 2005, entitled “Antriebswelle mit einem Antriebsgelenk für ein Kraftfahrzeug”; the entire contents and disclosure of which is hereby incorporated by reference in its entirety.

### TECHNICAL FIELD

Embodiments of the present invention relate to a driveshaft with a drive joint for a vehicle. More particularly, various embodiments relate to techniques for providing a predetermined breaking point for a driveshaft when a predefined torque moment threshold is exceeded.

### BACKGROUND

Automotive driveshafts transfer the drive torque moment from a motor-transmission combination to the vehicle's wheels. These driveshafts can thereby be constructed as side shafts for vehicles with a front-cross assembly of the motor transmission combination or as longitudinal shafts, such as cardan shafts. In the case of longitudinal shafts, a drive joint, such as a constant-velocity telescopic joint, is axially located between two shaft sections of the driveshaft. The first shaft section of the driveshaft is coupled to the transmission on one end and to the drive joint on the other end. The second shaft section is also coupled to the drive joint on one end and to a drive differential in the area of the vehicle's rear axle on the other end.

In the case of the driveshafts for vehicles constructed as side shafts, a constant-velocity telescopic joint or a tripod joint, which is drive-connected to the assigned wheel hub through its output element, is usually placed at the end of such a side shaft on the side of the vehicle's wheel. German Patent Application DE 101 54 254 A1 shows, for instance, a side shaft with a drive joint placed thereon and constructed as constant-velocity telescopic joint. The described drive joint essentially consists of a joint inner portion and a joint outer portion, such that part of the joint inner portion is axially contained in the joint outer portion. The joint inner portion and the joint outer portion feature a seating area with tracks pointing towards one another in which globes are positioned to transfer a torque moment from the joint inner portion to the joint outer portion.

In another configuration shown in German Patent Application DE 101 54 254 A1, a cross-sectional display shows a joint outer portion featuring different wall thicknesses in the seating area for the joint inner portion and for the globes. The tracks for the globes mark the thinnest areas of the seating area. More specifically, the tracks for the globes are integrated into the joint inner portion, while the joint outer portion features a mostly cylindrical or bell-shaped external geometry.

One disadvantage of the described configurations of the joint outer portion relates to the fact that the joint is built in a comparatively massive manner and, as a result, is very heavy. Hence, a driveshaft equipped with such a drive joint tends, in case of impermissibly high torque moments, to lend to a component failure. Insofar as the component failure of the driveshaft takes place in an area of the drop pipe, such as at weld seams or at other connection elements of the driveshaft, this causes the driveshaft to come apart. Component failure is absolutely to be avoided since the components of the driveshaft, which are powered on the side of the driveshaft and/or input shaft, rotate uncontrollably underneath the vehicle where significant damage can be caused without a sufficient number of bearing points.

Furthermore, joint outer portions for driveshafts are also available which are manufactured by means of a sheet reformation procedure to have about the same wall thickness throughout the joint. One disadvantage of this type of joint outer portion is the fact that it can often only transfer small torque moments, comparatively speaking. Moreover, the sheet-joint outer portions rupture, in cases where the torque moments are too high, in such a manner that the globes and the joint inner portion are released so that safety problems arise as a result of such a configuration.

### SUMMARY OF INVENTION

Although various embodiments of the invention are illustrated and described herein as embodied in a driveshaft and/or cardan shaft, it is, nevertheless, not intended to be limited to the details shown because various modifications and structural changes may be made therein without departing from the spirit of various embodiments of the invention and remain within the scope and range of equivalents of the claims.

It is accordingly believed that various embodiments of the invention, as described from the characteristics of the claims, provide a driveshaft that overcomes the hereinafore-mentioned disadvantages of the heretofore-available driveshaft devices of this general type and that can be configured to break at a predetermined breaking point upon exceeding a predefined torque moment threshold without the performance and safety problems associated with the heretofore-available driveshaft devices.

With the foregoing and other objects in view, there is provided, in accordance with at least one embodiment of the invention, an automotive driveshaft (1) having rolling elements and a drive joint (9) to provide a predetermined breaking point of the driveshaft (1). The drive joint (9) includes an inner portion and an outer portion (12). The outer portion (12) is configured to break at a predetermined breaking point upon exceeding a predefined torque moment threshold. The rolling elements, incorporated between the joint inner portion and the joint outer portion (12) of the drive joint (9), axially position and seat the joint inner portion into the joint outer portion (12) along tracks (16, 17).

Accordingly, embodiments of the invention present a driveshaft with a drive joint, which, due to its mechanical characteristics, is capable of transferring comparatively high torque moments and, which in case of impermissibly high torque moments, absorbs these in such a manner that the drive joint is destroyed. However, the drive joint keeps or maintains the joint inner portion and the joint outer portion together in an acceptable fashion.

In accordance with a feature of one embodiment of the invention, a driveshaft for a vehicle includes a drive joint in which the drive joint features a joint inner portion and a joint outer portion. The joint inner portion and the joint outer portion are axially integrated into one another and contain rolling elements in tracks between them. The joint outer portion is designed in such a manner that it serves and breaks as a predetermined breaking point of the driveshaft in the event a predefined torque moment threshold is exceeded during operation of the driveshaft.

In accordance with another feature of one embodiment, the joint outer portion is preferably built in such a manner that the joint continues to maintain a similar geometric shape in case of destruction. In various embodiments, the joint outer portion prevents the release of the joint inner portion.

According to a further feature of one embodiment, the joint outer portion functions as a predetermined breaking point of the driveshaft by means of a particular design of the wall thicknesses and/or density of the joint outer portion. According to an added feature of one embodiment, the wall thicknesses of the joint outer portion are essentially identical in the seating area for the joint inner portion of the drive joint. Yet another feature of one embodiment provides that the wall thickness D1, D3 of the joint outer portion in the area of the tracks for the rolling elements is lower than the wall thickness in the areas positioned between these tracks. According to another further feature of one embodiment of the invention, the wall thickness D1, D4 of the joint outer portion in the area of the tracks for the rolling elements is greater than the wall thickness D2, D3 in the areas positioned between the tracks.

A joint outer portion of the drive joint, formed in accordance to one of the feature variables of one embodiment, is, for instance, created by the fact that the joint outer portion of the drive joint features depressions pointing radially inward at its circumference in the areas which are located between the tracks on the inside for the rolling elements.

To realize the transfer of power from the joint outer portion to another power train component, which is connected with the joint outer portion, one embodiment provides for the shaft connection areas of the joint outer portion to feature another and preferably greater and/or thicker wall, as compared to the seating area for the joint inner portion.

In one embodiment, the joint outer portion can be manufactured for each type of construction of a drive joint to conform to the desired genre with a joint inner portion, a joint outer portion and rolling elements (balls, globes and/or other spherical objects) located within. In this way, the drive joint in one embodiment can be constructed as a constant-velocity telescopic joint or as a tripod joint. In various embodiments, the driveshaft can also be designed as either a longitudinal driveshaft or as side driveshaft.

Other features that are considered as characteristic for various embodiments of the invention are set forth in the appended claims. However, the construction and method of operation of various illustrated embodiments of the invention, together with additional objects and advantages thereof, will be best understood from the following description of specific embodiments when read in connection with the accompanying drawings.

### BRIEF DECRIPTION OF THE DRAWINGS

The present invention will be described by way of exemplary embodiments, but not limitations, illustrated in the accompanying drawings in which like references denote similar elements, and in which:

FIG. 1 is a perspective view of a telescope type cardan shaft with a drive joint according to various embodiments of the invention;

FIG. 2 is a perspective view of the drive joint according to FIG. 1; and

FIG. 3 is a cross-section view of the joint outer portion according to FIG. 2.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Reference in the specification to “one embodiment” or “an embodiment” means that a particular feature, structure, or characteristic described in connection with the embodiment is included in at least one embodiment. The appearances of the phrase “in one embodiment” in various places in the specification do not necessarily all refer to the same embodiment, but it may. The phrase “A/B” means “A or B”. The phrase “A and/or B” means “(A), (B), or (A and B)”. The phrase “at least one of A, B, and C” means “(A), (B), (C), (A and B), (A and C), (B and C) or (A, B and C)”. The phrase “(A) B” means “(A B) or (B)”, that is “A” is optional.

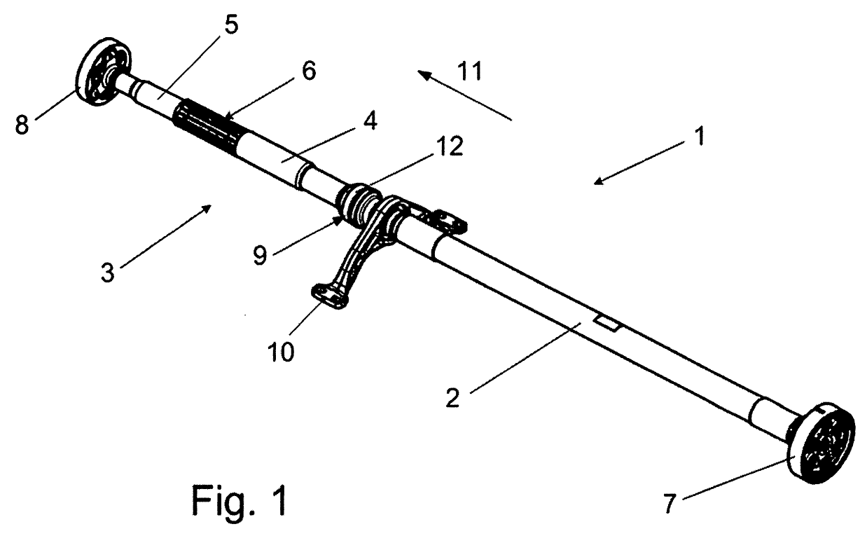

Referring to FIG. 1, a cardan shaft or a driveshaft 1, in accordance with one embodiment, embraces two partial shafts and which is, for instance, used in a vehicle with a front-cross assembly of the vehicle's drive motor and of the drives. A first shaft 2 is connected to the second shaft 3 through a drive joint 9, such as a constant-velocity telescopic joint. The constant-velocity telescopic joint of the driveshaft 1 is constructed according to desired failure characteristics of the drive joint 9 in one embodiment of the invention. A bearing block 10, in proximity to the constant-velocity telescopic joint, is superposable and designed to retain the cardan shaft in a central section at the subfloor of the vehicle by means of a central support.

At its free ends, both shafts 2 and 3 are connected to flexible joint disks 7 and 8. The forward direction of motion of the vehicle is indicated by arrow 11 so that joint disk 8 is connected with the output shaft of the vehicle's motor-transmission combination and joint disk 7 is connected with the input of a differential drive on the vehicle.

The collapsible second shaft 3 is designed in two parts and entails an initial shaft section 4 as well as a second shaft section 5, which can be slid coaxially into one another in the area of a sliding section when a sufficiently high axial force affects this shaft. In order to be able to realize the desired axial mobility, the shaft sections 4 and 5 of the second shaft 3 that point to one another are, for instance, to be provided with an axial interlocking which, additionally, enables a transfer of the torque moment, supports a targeted shifting motion, and is designed such a way that this kinetic energy can be transformed into radial distortion work and thermal energy, respectively.

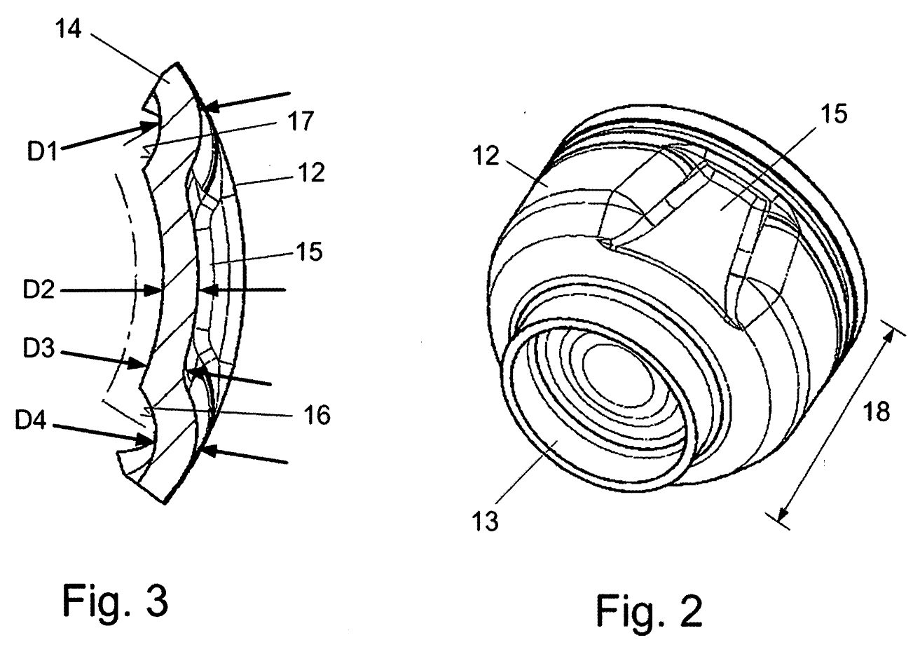

FIG. 2 shows a perspective view of a joint outer portion 12 of a drive joint 9, such as a constant-velocity telescopic joint, which features a seating section 18 for the axial retention of the joint inner portion and of the rolling elements (not displayed) as well as a shaft connection zone 13 in which the joint outer portion 12 can, for instance, be connected with the tube-shaped shaft section 4 of driveshaft 1 through a welding seam.

FIG. 2 clarifies countersink depressions 15 in the circumference of the joint outer portion that are preferably created in those areas of the joint outer portion 12 located between the internal tracks 16, 17 for the rolling elements relative to the circumference.

FIG. 3 illustrates this constructive setup on the basis of a cross-section display through a circumferential section of the joint outer portion 12 according to FIG. 1. The wall thickness D1 to D4 is predominantly identical at the cross-section surface 14 and across all circumferential sections of the joint outer portion as illustrated in FIG. 3. In order to position the rolling elements between the tracks 16, 17, the external geometry of the joint outer portion 12 features the earlier-mentioned depressions 15.

A joint outer portion 12 formed in this manner is able to absorb impermissibly high torque moments in such a manner that this component functions as a predetermined breaking point of the drive joint 9 and of the driveshaft 1, respectively. In fact, joint outer portion 12 breaks, but substantially maintains a geometric form so that drive joint 9 and driveshaft 1, respectively, do not fall apart. This joint component behavior is determined by the fact that, in the case of equal wall thickness of the joint outer portion 12, the distribution of tension in the same joint is more homogenous than in the case of the available joint outer portions with varying wall thicknesses. In addition, ductile areas in the material of the joint outer portion 12 are better distributed across the circumference of the same and, as a result of which, a more elastic absorption of peak loads is accomplished when underneath the destroying load limits.

A drive joint and joint outer portion, created in accordance with one embodiment of the invention, are clearly lighter than those devices constructed to current technology due to the manufactured wall thicknesses needed in the case of a comparable torque moment transferability.

Although specific embodiments have been illustrated and described herein, it will be appreciated by those of ordinary skill in the art and others that a wide variety of alternate and/or equivalent implementations may be substituted for the specific embodiment shown in the described without departing from the scope of the present invention. This application is intended to cover any adaptations or variations of the embodiment discussed herein. Therefore, it is manifested and intended that the invention be limited only by the claims and the equivalents thereof.

What is claimed is:

1. A driveshaft (1) comprising:
a drive joint (9) for an vehicle having an inner portion and an outer portion (12); the outer portion (12) of the drive joint (9) providing a predetermined breaking point of the driveshaft (1) as the outer portion (12) is configured to break upon exceeding a predefined torque moment threshold; and
rolling elements incorporated between the joint inner portion and the joint outer portion (12) of the drive joint (9) to axially position and to seat the joint inner portion into the joint outer portion (12) along tracks (16, 17).

2. The driveshaft according to claim 1, wherein the outer portion (12) of the drive joint (9) is configured to continue to maintain a geometric form during a breaking process of the outer portion (12).

3. The driveshaft according to claim 1, wherein the predetermined breaking point of the driveshaft is created based on a plurality of wall thicknesses (D1, D2, D3, and D4) of the outer portion (12) of the drive joint (9).

4. The driveshaft according to claim 3, wherein the plurality of wall thicknesses (D1, D2, D3, and D4) of the outer portion (12) of the drive joint (9) in a seating area (18) are essentially identical for the inner portion of the drive joint (9).

5. The driveshaft according to claim 3, wherein a first wall density (D1, D4) of an area of the tracks (16, 17) of the outer portion (12) of the drive joint (9) is lower than a second wall density (D2, D3) of areas located between the tracks (16, 17) of the outer portion (12) of the drive joint (9).

6. The driveshaft according to claim 3, wherein a first wall thickness (D1, D4) of an area of the tracks (16, 17) of the outer portion (12) of the drive joint (9) is greater than a second wall thickness (D2, D3) of areas located between the tracks (16, 17) of the outer portion (12) of the drive joint (9).

7. The driveshaft according to claim 1, wherein the outer portion (12) of the drive joint (9) includes inward pointing, radially extending depressions (15) along a circumference of the outer portion (12) between the internal tracks (16, 17) for the rolling elements.

8. The driveshaft according to claim 1, wherein a shaft connection area (13) of the outer portion (12) of the drive joint (9) has a different wall thickness than a seating area (18) of the inner portion of the drive joint (9).

9. The driveshaft according to claim 1, wherein the drive joint (9) is constructed as a constant-velocity telescopic joint or as a tripod joint.

10. The driveshaft according to claim 1, wherein the drive joint (9) is created as a longitudinal driveshaft (1) or as a side driveshaft.

11. A method, comprising:
providing a driveshaft (1) having a drive joint (9) with an outer portion (12) and an inner portion, the drive joint (9) configured to break according to a predetermined breaking point; and
upon exceeding a predefined torque moment threshold of the drive joint (9), the threshold being based in part on the predetermined breaking point, breaking the outer portion (12) of the drive joint (9).

12. The method according to claim 1 1, wherein the breaking includes maintaining a geometric form of the outer portion (12).

13. The method according to claim 11, wherein the providing the driveshaft includes selecting at least one driveshaft from a group consisting of a collapsible driveshaft, a slip in tube driveshaft, a longitudinal driveshaft, and/or a side driveshaft.

14. The method according to claim 11, wherein the providing the driveshaft includes selecting the drive joint from a group consisting of a constant-velocity joint, a telescopic joint, and/or a tripod joint.

15. A collapsible driveshaft system for an vehicle, comprising:
a first shaft (2) and a second shaft (3) configured to couple to a motor; and
a drive joint (9) coupled to the first shaft (2) and the second shaft (3), the drive joint (9) having an inner portion and an outer portion (12); the outer portion (12) configured to break upon exceeding a predefined torque moment threshold.

16. The collapsible driveshaft system according to claim 15, wherein the outer portion (12) of the drive joint (9) is configured to maintain a geometric form upon exceeding the predefined torque moment threshold.

17. The collapsible driveshaft system according to claim 16, wherein the predefined torque moment threshold is based on a desired predetermined breaking point of the driveshaft.

18. The collapsible driveshaft system according to claim 17, wherein the desired predetermined breaking point of the driveshaft is based in part on wall thicknesses (D1, D2, D3, D4) of the outer portion (12) of the drive joint (9).

19. The collapsible driveshaft system according to claim 15, wherein the drive joint (9) is constructed as a constant-velocity telescopic joint containing rolling elements and lead in tracks (16, 17) to axially place the inner portion and the outer portion (12) into one another.

20. The collapsible driveshaft system according to claim 19, wherein the tracks (16, 17) are on the outer portion (12) of the drive joint (9) and a first wall density (D1, D4) of the tracks (16, 17) is lower than a second wall density (D2, D3) of the outer portion (12) between the tracks (16, 17).
